(19) United States
(12) Patent Application Publication
(10) Pub. No.: US 2006/0265943 A1
(43) Pub. Date: Nov. 30, 2006

(54) Device for putting an anti-mite agent into a mattress

(76) Inventor: Rolf Hartmann, Karlsruhe (DE)

Correspondence Address: John S. Egbert;Harrison & Egbert, 7th Floor, 412 Main Street, Houston, TX, 77002, US

(21) Appl. No.: 11/136,297

(22) Filed: May 25, 2005

(51) Int. Cl. A01M 19/00

(52) U.S. Cl. 43/129

(57) ABSTRACT

The invention involves a device for putting an anti-mite agent into a mattress. In order to ensure that a mattress is not just sprayed on the surface with an anti-mite agent, it is proposed to provide a corresponding device with structural components which have at least one hollow needle, with which an outer covering of a mattress is punctured so that a mattress can be vaccinated using these devices with anti-mite agent.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention involves a device for putting an anti-mite agent into a mattress.

### BACKGROUND OF THE INVENTION

To an increasing extent, people who have allergies are suffering due to house dust. It is known that house dust becomes allergenic especially due to the excretions of house dust mites, which can be found in mattresses, for example, where they feed upon skin flakes, etc. In order to eliminate the house dusts mites, a wide range of possibilities have already been proposed in the prior art. In particular, there are proposals for cleaning the mattresses whereby the mattresses are put into corresponding cleaning machines.

However, it has also been discovered that the house dust mites can withstand even higher temperatures and pressures over a longer time, so that recently a transition has been made to treating mattresses with an anti-mite agent. To do this, it had been proposed to hold a nozzle over the mattress and to spray the anti-mite agent, usually a liquid, onto the mattress.

By this method, only a very superficial effect is achieved.

In order to reach deeper layers of the mattresses, it has been proposed to set the nozzle onto the mattress and to spray a corresponding anti-mite agent through it into the mattress.

In the process, it has been found to be problematic that in a procedure of this type, the anti-mite agent does not penetrate into the mattress very deeply, so that the successful treatment with the anti-mite agent is questionable.

### BRIEF SUMMARY OF THE INVENTION

In view of this, the purpose of the invention is to improve the devices that are known from the state of the art in order to ensure that anti-mite agent can actually be introduced into deeper areas of a mattress.

This purpose is achieved according to the invention in that the device for applying anti-mite agent into a mattress has a structural component that is provided with a hollow needle which punctures through the outer coating of the mattress.

The invention has the advantage that the especially dense outer covering of a mattress is penetrated by the hollow needle and the anti-mite agent can then be brought through the hollow needle into the layers lying under the outer covering. It can then become dispersed accordingly from that position.

In the process, it must also be taken into account that the front end of the hollow needle also acts as a nozzle when the anti-mite agent is sprayed through the hollow needle at a correspondingly high pressure, so that beneath the outer covering of the mattress, the anti-mite agent is not introduced as a jet but as a mist, or the like, into the mattress or the mattress core. In this way, an especially uniform distribution of the anti-mite agent, usually a liquid, is achieved.

In order to be able to create the correspondingly high pressure, it is proposed that the hollow needle communicate with a chamber from which anti-mite agent is pressed through the hollow needle via a piston. This produces the advantage of being able to create a correspondingly high pressure.

Preferably, the chamber is separated from the hollow needle via a valve using flow technology. This valve can be designed especially as a double non-return valve so that the chamber can be connected with a reservoir that contains the anti-mite agent as a tank, in order to be refilled when the connection to the hollow needle is turned off at the same time. When the piston causes pressure to build up again inside the chamber, the valve of the non-return valve which leads to the reservoir is closed and simultaneously the non-return valve to the hollow needle is opened, so that an additional movement of anti-mite agent into the mattress can be made. This is an especially operationally secure construction.

In addition, it must also be taken into consideration that the hollow needle is affixed to the structural component via a mount such that it can be replaced in order to accommodate different padding materials. In this process, it is to be taken into consideration whether the mattress is a feather-core or latex mattress, how the cores are filled with additional padding materials (wool, horsehair, wadding, etc.), etc.

The connection of the mount and hollow needle can be made, for example, via a bayonet connection, preferably here a threading is provided, since it possibly has a self-inhibiting mechanism and thus an unintended detachment of the hollow needle from the structural component is to be prevented.

The device can be constructed especially as a hand-held device. In this case, it has a trigger that acts on the piston and a handle.

It is also possible, however, to design the device as an installation element of a larger machine with several structural components that are arranged on a mount and share a common machine activation mechanism. In this way, a time-saving processing of a mattress, for example, over its entire width, can be done in one work step.

Preferably the mount is designed so that two supports that essentially lie opposite each other are provided on which the structural components are arranged in an orientation in which the hollow needles are facing each other.

In this way, a mattress can be treated simultaneously from its upper and lower side with a corresponding anti-mite agent.

### BRIEF DESCRIPTION OF THE SEVERAL VIEWS OF THE DRAWINGS

Additional advantages and characteristics of the invention result from the following description and embodiment examples.

FIG. 1 is a schematic view of a diagram of a device for applying anti-mite agent to a mattress.

FIG. 2 is a sectional view of a structural element with a hollow needle as a part of the device according to FIG. 1.

### DETAILED DESCRIPTION OF THE INVENTION

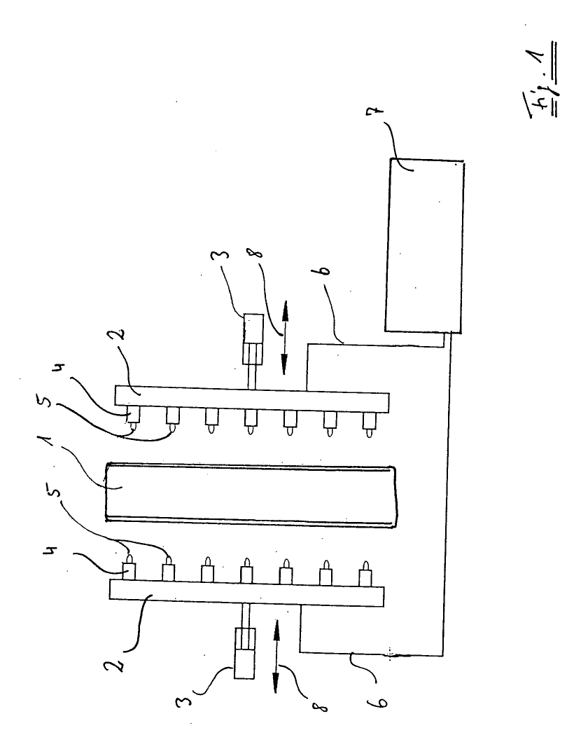

Shown in FIG. 1 is the principle diagram of a device for applying anti-mite agent to a mattress. This device is part of a larger mattress cleaning system which is not shown here in its entirety.

In this device, two supports 2 are guided onto a mattress 1 via pneumatic or hydraulic cylinder-piston assemblies 3. On these supports, structural components 4 that lie opposite each other are seated and are driven from opposite sides onto the mattress 1. The structural components 4 are facing each other and carry on their tips 5 that face each other either nozzles or, as shown in this example, hollow needles. This is explained in greater detail in the following.

Via these tips 5, after they are driven onto the mattress, an anti-mite agent is sprayed into them which for example is based on oil [Nehmöl]. This anti-mite agent is usually liquid and is supplied to the tips via lines 6 from a central tank 7.

After the corresponding anti-mite agent is brought into the mattress, the supports 2 are pulled back via the cylinder-piston assemblies 3 and after a movement between the mattress and the supports, they are guided onto the mattress in order to impinge the next strips of the mattress with anti-mite agent. The supports 2 thus continuously perform a movement towards each other and away from each other, as indicated by the double arrows 8.

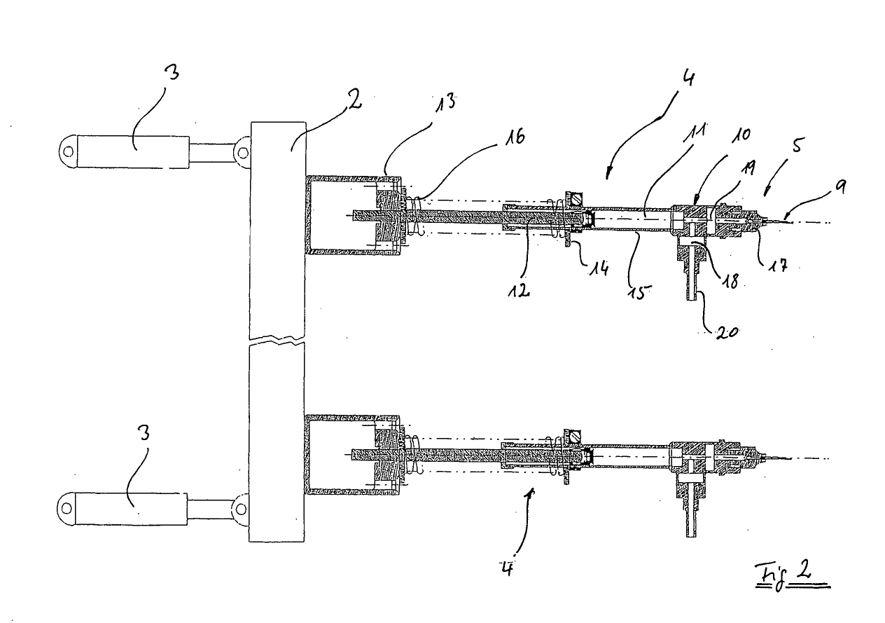

In FIG. 2, a corresponding support 2 is shown with structural components 4 that sit on it shown in greater detail.

It can be seen that the structural elements 4 on their ends that face away from the support 2 and/or tips 5 carry hollow needles 9. These hollow needles communicate via the connection, in particular a valve 10, with a chamber 11. In this chamber 11, a piston 12 can be introduced, whereby then liquid located in the chamber 11 gets through the valve 10 and the hollow needle 9.

The piston 12 is connected via a reinforcement 13 to the support 2. Between the reinforcement 13 and the flange 14, which is mounted on the wall 15 of the chamber 11, another compression spring 16 is located.

The entire structural component 4 functions as follows:

When the support 2 is shifted forward by the cylinder-piston assemblies 3, the hollow needles 9 are pressed through the covering of a mattress (not shown), until the mount 17 of the hollow needle 9 comes to rest on the mattress.

In another drive forward of the support 2 via the cylinder-piston assemblies 3, the piston 12 is then pressed into the chamber 11, whereby as mentioned above, the liquid located in the chamber 11 is brought through the hollow needle 9 into the mattress. In the process, a non-return valve 18 closes in the valve 10, while a second non-return valve 19 opens towards the hollow needle.

At the same time, when the piston 12 is pushed forward into the chamber 11, the compression spring 16 is compressed.

When the support 2 is pulled back via the cylinder-piston assemblies 3, the spring 16 will relax again whereby it is then moved relative to the piston 12 via the flange 14 in the opposite direction of the wall of the chamber 11, such that the chamber 11 is filled again with anti-mite agent. For this purpose, the second non-return valve 19 to the hollow needle is closed and the non-return valve 18 opens so that via the extension 20 that is connected to the line 6 and the tank 7, anti-mite agent can flow back into the chamber 11.

By setting the hollow needle 9 onto adjacent points of the mattress 1 again, this operation is correspondingly repeated.

Thus, there is the possibility for providing a mattress completely with anti-mite agent in a quasi-continuous operation, in order to thus be able to create certain attacks against the house dust mites in the mattress.

At this point it should also be mentioned that the mount 17 for the hollow needle 9 can be detached via a threading or a bayonet connection from the valve body 10, in order to set down fresh or different hollow needles 9.

Furthermore, it should be mentioned that the support 2, for example, can be also be mounted on a handle that is manually operated, by which in the principle of the same function as described above, a mattress can be vaccinated manually with suitable anti-mite agent. Manually spraying or blowing in anti-mite agent, possibly while omitting the support 2, is also within the context of the invention.

1-7. (canceled)

8. Device for introducing anti-mite agent into a mattress, comprising:
a structural component with at least one hollow needle for puncturing an outer covering of the mattress.

9. Device according to claim 8, wherein said hollow needle communicates with a chamber from which using a piston, anti-mite agent is pressed through the hollow needle.

10. Device according to claim 9, wherein said chamber is separated by flow technology via a valve from the hollow needle and is connected with a tank to be refilled.

11. Device according to claim 8, wherein said hollow needle is replaceable via a mount.

12. Device according to claim 8, further comprising:
a handle with a trigger acting on a piston.

13. Device according to claim 8, further comprising:
a mounting element of several structural components arranged on a mount, making use of a machine activation.

14. Device according to claim 13, wherein said mount has at least two supports that lie opposite each other, on the structural elements of which hollow needles are arranged in an orientation facing each other.
